(19) United States
(12) Patent Application Publication
(10) Pub. No.: US 2013/0280597 A1
(43) Pub. Date: Oct. 24, 2013

(54) BATTERY PACK, SECONDARY BATTERY HOUSING CASE, AND BATTERY PACK ASSEMBLING METHOD

(71) Applicant: Shinichi Yamamoto, Hyogo (JP)

(72) Inventor: Shinichi Yamamoto, Hyogo (JP)

(73) Assignee: PANASONIC CORPORATION, Osaka (JP)

(21) Appl. No.: 13/996,954

(22) PCT Filed: Nov. 24, 2011
(86) PCT No.: PCT/JP2011/006523

§ 371 Date: Jun. 21, 2013

(30) Foreign Application Priority Data
Dec. 27, 2010 (JP) 2010-290141

(51) Int. Cl. H01M 2/10

(52) U.S. Cl. CPC H01M 2/1022
USPC 429/176; 429/163; 29/623.1

(57) ABSTRACT

A battery having a box-shaped secondary battery storage case including a lower case and an upper case, and a secondary battery to be housed therein are provided. A roof insertion piece of the upper case is inserted into the lower case so as to be in contact with a roof sheet portion of the lower case, an upper insertion piece of the upper case is inserted into the lower case so as to be in contact with a back side wall of the lower case, and a lower insertion piece of the lower case is inserted into the upper case so as to be in contact with a back side wall of the upper case. This allows the secondary battery to be housed in the secondary battery storage case.

### TECHNICAL FIELD

The present disclosure relates to battery packs each including a secondary battery housed in an outer case, secondary battery storage cases in each of which a secondary battery is housed, and methods for assembling a battery pack while housing a secondary battery in an outer case.

### BACKGROUND ART

Devices including a secondary battery as a power source, such as mobile phones, laptop personal computers, and portable compact disc (CD) or mini disc (MD) players, have been used in many fields.

Battery packs for use in such devices are each configured to house a thin secondary battery between upper and lower cases made of a synthetic resin as described in, e.g., PATENT DOCUMENT 1. Ultrasonic welding is usually employed to fix the upper and lower cases.

However, ultrasonic energy in ultrasonic welding may affect a secondary battery and a protective circuit substrate connected to the secondary battery. For example, ultrasonic energy may cause a crack in, e.g., connecting portions between electronic components mounted on the protective circuit substrate, and connection between the electronic components may be in an open state. Furthermore, ultrasonic energy may cause a safety valve of a secondary battery to open, or may disconnect an electrode from a corresponding component, leading to problems, i.e., electrolyte leakage or a deterioration in performance.

To address the problems, PATENT DOCUMENT 2 describes a battery pack configured to house a secondary battery in a storage case including an upper case that has left and right side surfaces each including a fitting protrusion, and has an end surface including a latch nail, and a lower case that has left and right side surfaces each including a fitting groove, and has an end surface including a latch hole.

In the battery pack, the upper case is slid over the lower case with the fitting protrusions of the side surfaces of the upper case being fitted into the fitting grooves of the side surfaces of the lower case, and the secondary battery is housed in the storage case. The upper and lower cases are fixed by respectively fitting the fitting protrusions of the side surfaces of the upper case and the latch nail of the end surface of the upper case into the fitting grooves of the side surfaces of the lower case and the latch hole of the end surface of the lower case to lock the upper and lower cases.

### CITATION LIST

### Patent Documents

PATENT DOCUMENT 1: Japanese Patent Publication No. 2005-100689
PATENT DOCUMENT 2: Japanese Patent Publication No. 2007-103284

### SUMMARY OF THE INVENTION

### Technical Problem

However, when, in the above-described battery pack, the upper and lower cases are fitted together, the fitting protrusions of the left and right side surfaces of the upper case need to be aligned with the fitting grooves of the left and right side surfaces of the lower case; however, since the fitting protrusions and the fitting grooves have a fine structure, the alignment is difficult, and thus, it is difficult to easily house the secondary battery in the storage case.

Furthermore, when the upper case is slid over the lower case, the latch nail of the upper case is not fitted into the latch hole of the lower case. Even when the slide operation finishes, and the latch nail is fitted into the latch hole, the latch nail is easily detached from the latch hole by again applying the same force as a force applied to the upper case to slide the upper case in the direction opposite to the direction of application of the force to the upper case, and thus, the storage case is easily opened. This cannot ensure the accommodation of the secondary battery in the storage case.

The present disclosure has been made in view of the problems, and it is an object of the present disclosure to provide a battery pack in which a secondary battery is easily and reliably housed in a storage case, and a secondary battery storage case that can easily and reliably house a secondary battery, and a method for assembling a battery pack.

### Solution to the Problem

A battery pack according to a first aspect of the present disclosure includes: a secondary battery storage case including a lower case, and an upper case joined to the lower case; and a secondary battery housed in the secondary battery storage case. The lower case includes a bottom plate, and a surrounding side wall standing around the bottom plate so as to be directed upward, and including left, right, front, and back side walls, the upper case includes a top, and a surrounding side wall standing around the top so as to be directed downward, and including left, right, and back side walls, an upper portion of the front side wall of the lower case includes a roof sheet portion protruding backward, a front portion of the top of the upper case includes a roof insertion piece that is inserted into the roof sheet portion so as to be in contact with the roof sheet portion, at least one of an upper insertion piece of the back side wall of the upper case or a lower insertion piece of the back side wall of the lower case is provided, where the upper insertion piece is inserted into the lower case so as to be in contact with the back side wall of the lower case, and the lower insertion piece is inserted into the upper case so as to be in contact with the back side wall of the upper case, and a space surrounded by the top and surrounding side wall of the upper case and the bottom plate and surrounding side wall of the lower case is formed as a space for housing the secondary battery by inserting the roof insertion piece of the upper case into the lower case such that the roof insertion piece is in contact with the roof sheet portion of the lower case, and at least either inserting the upper insertion piece into the lower case such that the upper insertion piece is in contact with the back side wall of the lower case, or inserting the lower insertion piece into the upper case such that the lower insertion piece is in contact with the back side wall of the upper case to house the secondary battery in the secondary battery storage case.

With the configuration, the secondary battery is placed on the bottom plate of the lower case, and the upper case is, for example, obliquely inserted into the lower case such that the roof insertion piece of the upper case is in contact with the roof sheet portion of the lower case, thereby facilitating alignment between the upper and lower cases. Furthermore, after the roof insertion piece has been inserted below the roof sheet portion, the upper insertion piece of the upper case is inserted into the lower case so as to be in contact with the back side wall of the lower case, or the lower insertion piece of the lower case is inserted into the upper case so as to be in contact with the back side wall of the upper case, such that the back side wall of the upper case is brought closer to the back side wall of the lower case. This makes it difficult for the inserted insertion piece to become detached, thereby ensuring the accommodation of the secondary battery.

A locking recess is preferably formed in the upper insertion piece of the upper case, and a front portion of the back side wall of the lower case preferably includes a locking portion that is inserted into the locking recess and is capable of locking the upper insertion piece.

With the configuration, after the upper insertion piece of the upper case has been inserted into the lower case so as to be in contact with the back side wall of the lower case, the locking portion formed in the front portion of the back side wall of the lower case is inserted into the locking recess formed in the upper insertion piece of the upper case to lock the upper insertion piece. This makes it more difficult for the inserted upper insertion piece to become detached.

A locking recess is preferably formed in the lower insertion piece of the lower case, and a front portion of the back side wall of the upper case preferably includes a locking portion that is inserted into the locking recess and is capable of locking the lower insertion piece.

With the configuration, after the lower insertion piece of the lower case has been inserted into the upper case so as to be in contact with the back side wall of the upper case, the locking portion formed in the front portion of the back side wall of the upper case is inserted into the locking recess formed in the lower insertion piece of the lower case to lock the lower insertion piece. This makes it more difficult for the inserted lower insertion piece to become detached.

Preferably, an insertion recess is formed in the front portion of the back side wall of the upper case, and the lower insertion piece of the lower case is inserted into the insertion recess.

With the configuration, the lower insertion piece of the lower case is inserted into the insertion recess formed in the front portion of the back side wall of the upper case. This makes it difficult for the lower insertion piece to move in a direction perpendicular to the lower insertion piece, thereby further ensuring the accommodation of the secondary battery in the storage case.

Preferably, an insertion recess is formed in a lower portion of the roof sheet portion of the lower case, and the roof insertion piece of the upper case is inserted into the insertion recess.

With the configuration, the roof insertion piece of the upper case is inserted into the insertion recess formed in the lower portion of the roof sheet portion of the lower case. This makes it difficult for the roof insertion piece to move in a direction perpendicular to the roof insertion piece, thereby further ensuring the accommodation of the secondary battery in the storage case.

The roof sheet portion of the lower case preferably includes a protruding portion inserted into the upper case so as to be in contact with the top of the upper case and protruding backward.

With the configuration, in alignment between the upper and lower cases, the roof insertion piece of the upper case is inserted below the roof sheet portion of the lower case, and the protruding portion of the roof sheet portion of the lower case is inserted below the top of the upper case. This allows the protruding portion to support, from below, the upper case including the roof insertion piece inserted below the roof sheet portion, thereby accurately maintaining a situation where the upper and lower cases are aligned with each other such that the upper case is, for example, obliquely inserted into the lower case.

Preferably, the upper insertion piece of the upper case includes a plurality of upper insertion pieces, the lower insertion piece of the lower case includes a plurality of lower insertion pieces, the upper insertion pieces and the lower insertion pieces are alternately arranged along a lateral direction, the upper insertion pieces of the upper case are inserted into the lower case so as to be in contact with the back side wall of the lower case, and the lower insertion pieces of the lower case are inserted into the upper case so as to be in contact with the back side wall of the upper case.

With the configuration, the plurality of upper insertion pieces of the upper case and the plurality of lower insertion pieces of the lower case are alternately arranged, thereby further ensuring the accommodation of the secondary battery in the storage case.

Preferably, at least a left or right end portion of the upper case includes an L-shaped insertion piece extending from a location within the front portion of the top to a front portion of a corresponding one of the left and right side walls and having an L-shaped cross section, and the L-shaped insertion piece is inserted into the lower case so as to be in contact with the roof sheet portion and a corresponding one of the left and right side walls of the lower case.

With the configuration, after the upper and lower cases have been joined together, the L-shaped insertion piece is inserted into the lower case so as to be in contact with the roof sheet portion and the left or right side wall of the lower case. This insertion prevents rattling of the housed secondary battery in vertical and lateral directions.

Preferably, an upper portion of the back side wall of the upper case includes a handle used to lift a back end portion of the upper case to remove the battery pack after attaching the battery pack, and the upper insertion piece of the upper case is provided adjacent to the handle in a lateral direction or below the handle.

With the configuration, the upper insertion piece of the upper case is provided in the vicinity of the handle. Therefore, when the battery pack is removed by grasping the handle, the upper and lower cases are less likely to be detached from each other.

An opening is preferably formed in each of a central portion of the top of the upper case and a central portion of the bottom plate of the lower case.

With the configuration, the opening is formed in each of the central portion of the top of the upper case and the central portion of the bottom plate of the lower case. This can reduce the weights of the upper and lower cases, and allows frames around the opening of the top and the opening of the bottom plate to support the secondary battery, thereby preventing rattling of the housed secondary battery in vertical directions.

The upper case, the lower case, and the secondary battery are preferably coated with an exterior label.

The configuration allows the exterior label to firmly support the secondary battery housed in the storage case to ensure the accommodation of the secondary battery in the storage case, and allows, e.g., necessary information to be printed on the exterior label.

A box-shaped secondary battery storage case according to a second aspect of the present disclosure includes: a lower case; and an upper case joined to the lower case. The lower case includes a bottom plate, and a surrounding side wall standing around the bottom plate so as to be directed upward, and including left, right, front, and back side walls, the upper case includes a top, and a surrounding side wall standing around the top so as to be directed downward, and including left, right, and back side walls, an upper portion of the front side wall of the lower case includes a roof sheet portion protruding backward, a front portion of the top of the upper case includes a roof insertion piece that is inserted into the roof sheet portion so as to be in contact with the roof sheet portion, at least one of an upper insertion piece of the back side wall of the upper case or a lower insertion piece of the back side wall of the lower case is provided, where the upper insertion piece is inserted into the lower case so as to be in contact with the back side wall of the lower case, and the lower insertion piece is inserted into the upper case so as to be in contact with the back side wall of the upper case, and a space surrounded by the top and surrounding side wall of the upper case and the bottom plate and surrounding side wall of the lower case is formed as a space for housing the secondary battery by inserting the roof insertion piece of the upper case into the lower case such that the roof insertion piece is in contact with the roof sheet portion of the lower case, and at least either inserting the upper insertion piece into the lower case such that the upper insertion piece is in contact with the back side wall of the lower case, or inserting the lower insertion piece into the upper case such that the lower insertion piece is in contact with the back side wall of the upper case.

A method for assembling a battery pack while housing a secondary battery in a box-shaped secondary battery storage case including a lower case and an upper case joined to the lower case according to a third aspect of the present disclosure, where the lower case includes a bottom plate, a surrounding side wall standing around the bottom plate so as to be directed upward, and including left, right, front, and back side walls, a roof sheet portion provided on an upper portion of the front side wall to protrude backward, and a lower insertion piece provided on the back side wall, and the upper case includes a top, a surrounding side wall standing around the top so as to be directed downward, and including left, right, and back side walls, a roof insertion piece provided on a front portion of the top and inserted into the roof sheet portion so as to be in contact with the roof sheet portion, and an upper insertion piece provided on the back side wall, includes steps of: placing the secondary battery on the bottom plate of the lower case; obliquely inserting the upper case into the lower case including the bottom plate on which the secondary battery has been placed, such that the roof insertion piece of the upper case is inserted into the lower case so as to be in contact with the roof sheet portion of the lower case; and bringing the back side wall of the upper case closer to the back side wall of the lower case, and housing the secondary battery in the secondary battery storage case at least either by inserting the upper insertion piece into the lower case such that the upper insertion piece is in contact with the back side wall of the lower case, or by inserting the lower insertion piece into the upper case such that the lower insertion piece is in contact with the back side wall of the upper case.

### Advantages of the Invention

According to the present disclosure, the roof insertion piece of the upper case is, for example, obliquely inserted into the roof sheet portion of the lower case, and the insertion piece of the upper or lower case is subsequently inserted into the lower or upper case so as to be in contact with the back side wall of the lower or upper case. Therefore, the secondary battery can be easily and reliably housed in the storage case.

### BRIEF DESCRIPTION OF THE DRAWINGS

FIG. 1 is a perspective view of a battery pack according to an embodiment when viewed obliquely from front before roof insertion pieces of an upper case of the battery pack are inserted into a roof sheet portion of a lower case of the battery pack.

FIG. 2 is a perspective view of the battery pack according to the embodiment, where the roof insertion pieces of the upper case of the battery pack has been inserted into the roof sheet portion of the lower case of the battery pack, when viewed obliquely from back.

FIG. 3 is a cross-sectional view taken along the line III-III illustrated in FIG. 1 when the lower and upper cases have been joined together.

FIG. 4 is a cross-sectional view taken along the line IV-IV illustrated in FIG. 1 when the lower and upper cases have been joined together.

FIG. 5 is a cross-sectional view taken along the line V-V illustrated in FIG. 2 when the lower and upper cases have been joined together.

FIG. 6 is a cross-sectional view taken along the line VI-VI illustrated in FIG. 2 when the lower and upper cases have been joined together.

FIG. 7 is a diagram illustrating a situation where the upper and lower cases are aligned with each other by inserting the upper case into the lower case from an oblique angle.

FIG. 8 is a diagram illustrating a situation where a secondary battery is housed in a secondary battery storage case.

FIG. 9 is a diagram illustrating a situation where the secondary battery storage case and the secondary battery are coated with an exterior label.

### DESCRIPTION OF EMBODIMENTS

Embodiments of the present disclosure will be specifically described hereinafter with reference to the accompanying drawings. The embodiments below are intended for easy understanding of the principle of the present disclosure. The scope of the invention is not limited to the embodiments below, and includes other embodiments expected by those skilled in the art.

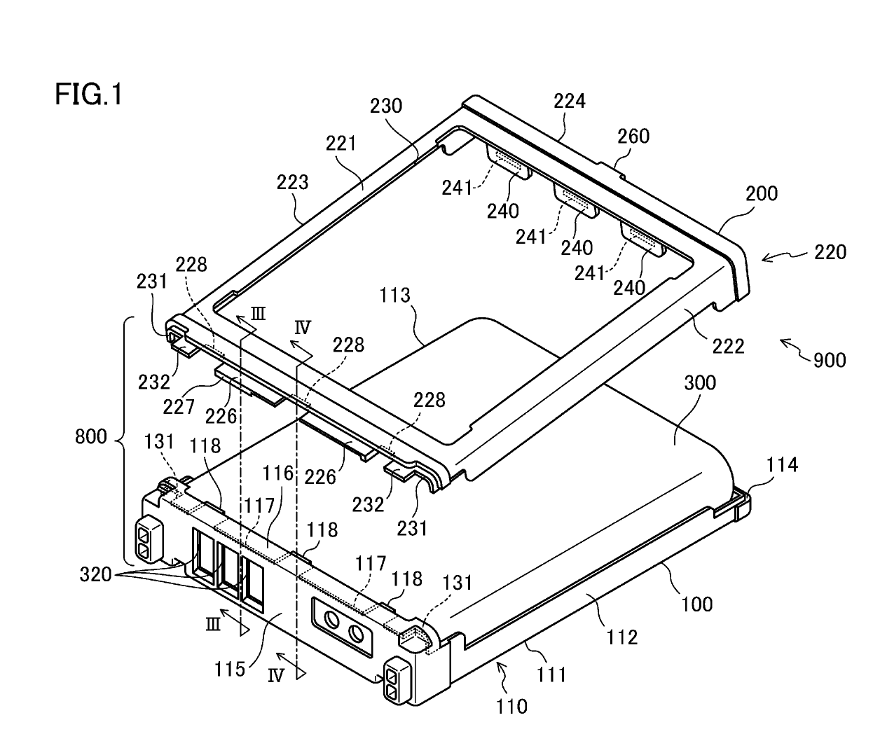

FIG. 1 is a perspective view of a battery pack 900 according to this embodiment when viewed obliquely from front before roof insertion pieces 226 of an upper case 200 of the battery pack 900 are inserted into a roof sheet portion 116 of a lower case 100 of the battery pack 900. As illustrated in FIG. 1, a secondary battery storage case 800 includes a lower case 100, and an upper case 200 joined to the lower case 100. The battery pack 900 is configured such that a secondary battery 300 is housed in the box-shaped secondary battery storage case 800. While the battery pack 900 may include an exterior label described below, it does not need to include the exterior label. The secondary battery 300 is not specifically limited, and is a flat prismatic lithium ion secondary battery, for example. As described below, a circuit substrate is disposed on an end surface of the secondary battery 300 near a sealing plate so as to be opposed to the secondary battery 300, and a molding is formed between the circuit substrate and the secondary battery 300 by curing a resin, thereby connecting the secondary battery 300 and the circuit substrate together. The material of the lower and upper cases 100 and 200 is not specifically limited, and is, for example, a synthetic resin, specifically, e.g., polycarbonate resin or acrylonitrile-butadiene-styrene resin.

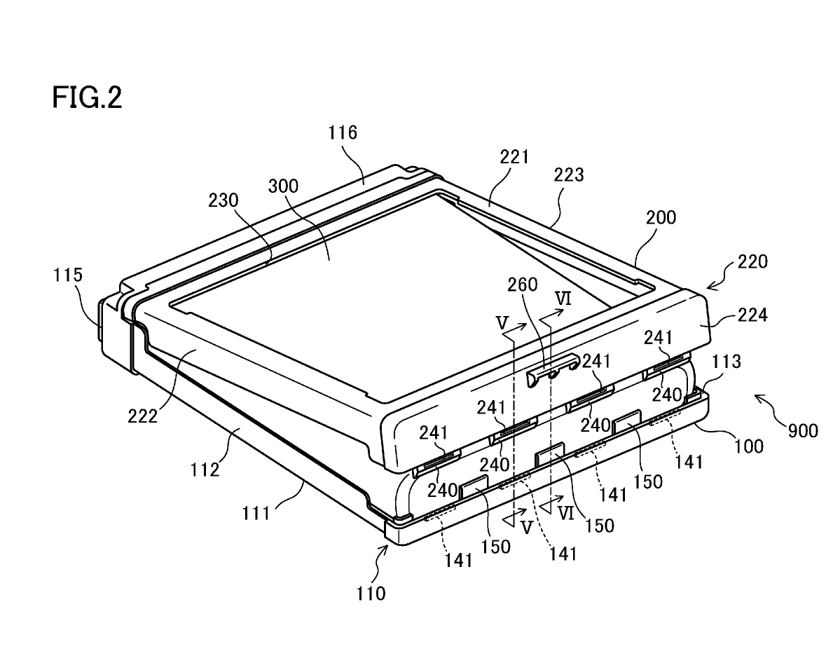

FIG. 2 is a perspective view of the battery pack 900 according to this embodiment, where the roof insertion pieces 226 of the upper case 200 of the battery pack 900 are inserted into the roof sheet portion 116 of the lower case 100 of the battery pack 900, when viewed obliquely from back. As illustrated in FIGS. 1 and 2, the upper case 200 has a top 221, and a surrounding side wall 220 formed on the top 221 to vertically extend downward from the top 221. The surrounding side wall 220 of the upper case 200 includes a left side wall 222, a right side wall 223, and a back side wall 224. An opening 230 is formed in a central portion of the top 221.

The lower case 100 has a bottom plate 111, and a surrounding side wall 110 standing on the bottom plate 111. The top 221 of the upper case 200 is opposed to the bottom plate 111. The surrounding side wall 110 of the lower case 100 includes a left side wall 112, a right side wall 113, a back side wall 114, and a front side wall 115. The front side wall 115 has external connection terminal openings 320 for externally exposing positive and negative electrode terminals of the secondary battery 300 and an external connection terminal that is a temperature detection terminal. Similar to the opening 230 of the top 221, an opening is formed also in a central portion of the bottom plate 111 of the lower case 100.

Since the opening is formed in each of the top 221 and the bottom plate 111, this can reduce the weights of the upper and lower cases 200 and 100.

An upper portion of the front side wall 115 of the lower case 100 includes a roof sheet portion 116 protruding backward. A front portion of the top 221 of the upper case 200 includes the roof insertion pieces 226, and a front end portion of one of the roof insertion pieces 226 includes a downward protruding portion 227 that protrudes downward.

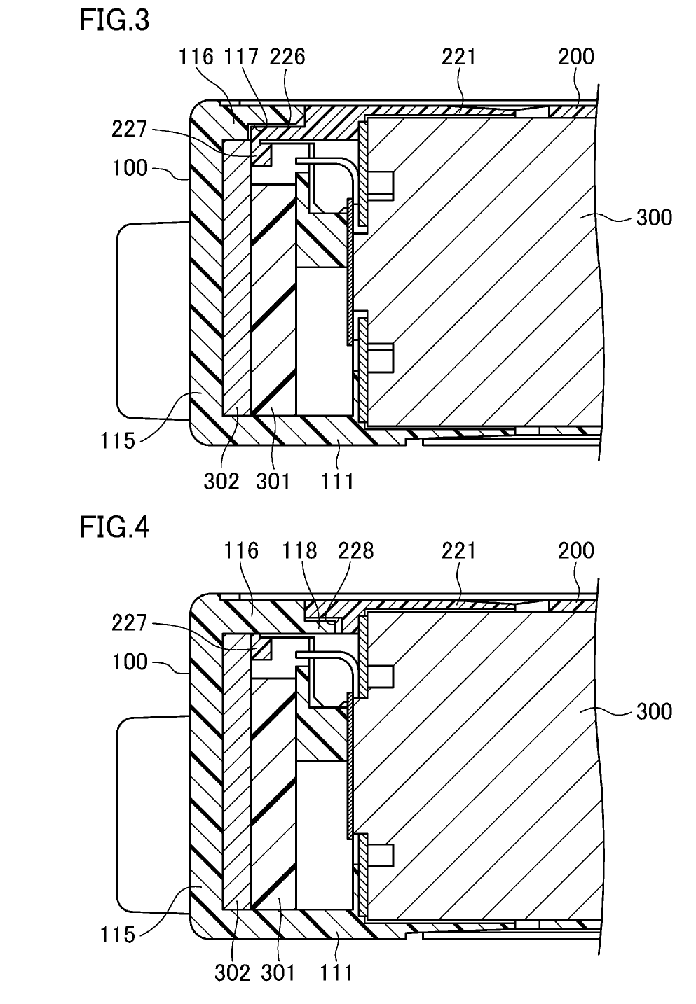

FIG. 3 is a cross-sectional view taken along the line III-III illustrated in FIG. 1 when the lower and upper cases 100 and 200 are joined together. As illustrated in FIGS. 1 and 3, insertion recesses 117 are formed in a lower surface of the roof sheet portion 116 of the lower case 100. The roof insertion pieces 226 are formed below an uppermost surface of the top 221 to protrude from a front surface of the top 221. The roof insertion pieces 226 are inserted into the corresponding insertion recesses 117 so as to be in contact with the roof sheet portion 116. Furthermore, when the lower and upper cases 100 and 200 are joined together, an upper portion of a circuit substrate 302 is sandwiched between the downward protruding portion 227 and the front side wall 115 of the lower case 100 to fix the circuit substrate 302. An upper portion of a molding 301 is below the upper portion of the circuit substrate 302, and when the lower and upper cases 100 and 200 are joined together, a space is formed above the molding 301, and the downward protruding portion 227 is fitted into the space.

When the upper case 200 is, for example, obliquely inserted into the lower case 100 such that the roof insertion pieces 226 are in contact with the roof sheet portion 116 of the lower case 100, the upper and lower cases 200 and 100 are easily aligned with each other. When the upper case 200 is obliquely inserted into the lower case 100 such that the roof insertion pieces 226 are in contact with the roof sheet portion 116 of the lower case 100, the downward protruding portion 227 does not impinge on the molding 301, and thus, is not caught thereon, because the space into which the downward protruding portion 227 is to be fitted is formed over the molding 301. Furthermore, since the roof insertion pieces 226 are inserted into the insertion recesses 117, this makes it difficult for the roof insertion pieces 226 to move in directions perpendicular to the roof insertion pieces 226, i.e., in lateral directions of the secondary battery storage case 800, thereby ensuring the accommodation of the secondary battery 300.

As illustrated in FIG. 1, the roof sheet portion 116 of the lower case 100 includes protruding portions 118 that protrude backward.

FIG. 4 is a cross-sectional view taken along the line IV-IV illustrated in FIG. 1 when the lower and upper cases 100 and 200 are joined together. As illustrated in FIGS. 1 and 4, recesses 228 are formed in a lower portion of a front surface of the top 221 of the upper case 200. The protruding portions 118 are formed below an uppermost surface of the roof sheet portion 116 to protrude from the back surface of the roof sheet portion 116. The protruding portions 118 are inserted into the corresponding recesses 228 so as to be in contact with the top 221. Since the protruding portions 118 are inserted into the recesses 228, the alignment between the upper and lower cases 200 and 100 allows the protruding portions 118 to support, from below, the upper case 200 including the roof insertion pieces 226 inserted below the roof sheet portion 116, thereby accurately maintaining a situation where the upper and lower cases 200 and 100 are aligned with each other such that the upper case 200 is, for example, obliquely inserted into the lower case 100.

As illustrated in FIG. 1, left and right end portions of the top 221 each include an L-shaped insertion piece 231 extending from a location within the front portion of the top 221 to a corresponding one of the left side wall 222 and the right side wall 223 and having an L-shaped cross section. The L-shaped insertion piece 231 includes a sheet-like protruding portion 232 formed below the uppermost surface of the top 221 to protrude frontward. An L-shaped recess 131 is formed in the lower surface of the roof sheet portion 116 of the lower case 100 to correspond to the shape of the L-shaped insertion piece 231, and the L-shaped insertion piece 231 is inserted into the corresponding L-shaped recess 131 so as to be in contact with the roof sheet portion 116 and a corresponding one of the left and right side walls 222 and 223.

After the upper and lower cases 200 and 100 have been joined together, the L-shaped insertion pieces 231 are each inserted into the lower case 100 so as to be in contact with the roof sheet portion 116 and a corresponding one of the left and right side walls 112 and 113. This insertion can accurately reduce rattling of the housed secondary battery 300.

As illustrated in FIG. 1, the back side wall 224 of the upper case 200 includes a plurality of upper insertion pieces 240.

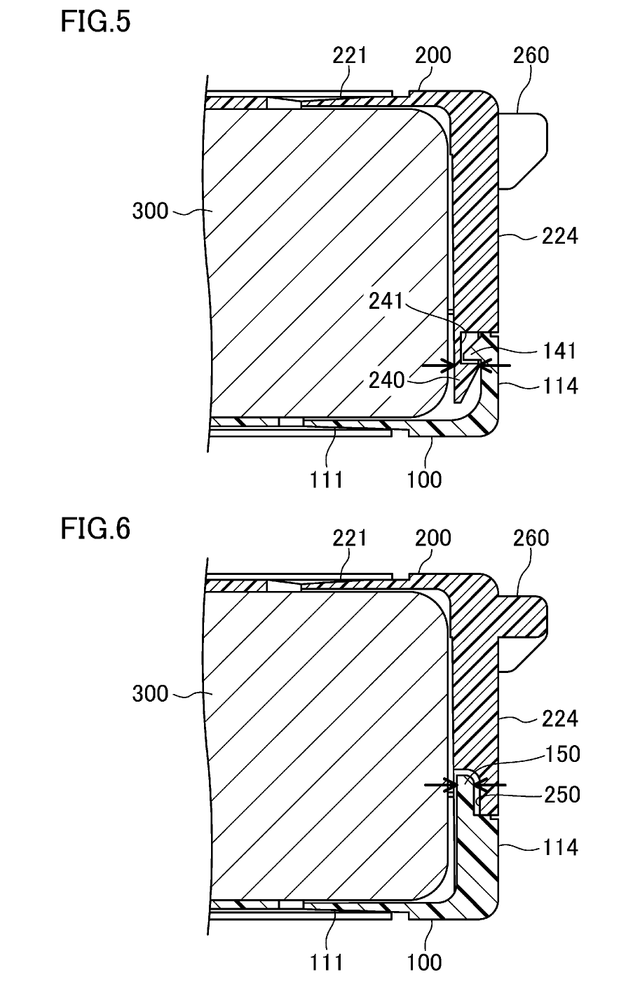

FIG. 5 is a cross-sectional view taken along the line V-V illustrated in FIG. 2 when the lower and upper cases 100 and 200 are joined together. As illustrated in FIG. 5, the upper insertion pieces 240 of the upper case 200 are inserted into the lower case 100 so as to be in contact with the back side wall 114 of the lower case 100. The upper insertion pieces 240 each have a cross section that is tapered toward its distal end, such as a triangular cross section, in order to facilitate inserting the upper insertion pieces 240 into the lower case 100 such that the upper insertion pieces 240 are in contact with the back side wall 114 of the lower case 100.

As illustrated in FIGS. 1, 2, and 5, the upper insertion pieces 240 of the upper case 200 each have a locking recess 241. A front portion of the back side wall 114 of the lower case 100 includes nail-shaped locking portions 141 that are inserted into the corresponding locking recesses 241 and are capable of locking the upper insertion pieces 240.

When the secondary battery 300 is housed in the secondary battery storage case 800, the upper insertion pieces 240 of the upper case 200 are inserted into the lower case 100 so as to be in contact with the back side wall 114 of the lower case 100. This makes it difficult for the inserted upper insertion pieces 240 to become detached, thereby ensuring the accommodation of the secondary battery 300. Furthermore, since the locking portions 141 are inserted into the locking recesses 241 formed in the upper insertion pieces 240 to lock the upper insertion pieces 240, this makes it difficult for the inserted upper insertion pieces 240 to become detached.

Moreover, as illustrated in FIG. 2, the back side wall 141 of the lower case 100 includes a plurality of lower insertion pieces 150.

FIG. 6 is a cross-sectional view taken along the line VI-VI illustrated in FIG. 2 when the lower and upper cases 100 and 200 are joined together. As illustrated in FIG. 6, the lower insertion pieces 150 of the lower case 100 are inserted into the upper case 200 so as to be in contact with the back side wall 224 of the upper case 200. The lower insertion pieces 150 of the lower case 100 protrude behind the back surface of the back side wall 114.

Insertion recesses 250 are formed in a front surface of the back side wall 224 of the upper case 200 to correspond to the shape of the lower insertion pieces 150 of the lower case 100, and the lower insertion pieces 150 are inserted into the corresponding insertion recesses 250 so as to be in contact with the back side wall 224.

When the secondary battery 300 is housed in the secondary battery storage case 800, the lower insertion pieces 150 of the lower case 100 are inserted into the upper case 200 so as to be in contact with the back side wall 224 of the upper case 200. This makes it difficult for the inserted lower insertion pieces 150 to become detached, thereby ensuring the accommodation of the secondary battery 300. Furthermore, since the lower insertion pieces 150 are inserted into the insertion recesses 250, this makes it difficult for the lower insertion pieces 150 to move in lateral directions, thereby accurately reducing rattling of the housed secondary battery 300.

As illustrated in FIG. 2, the number of the upper insertion pieces 240 of the upper case 200 is, for example, four, and the number of the lower insertion pieces 150 of the lower case 100 is, for example, three. When the upper insertion pieces 240 of the upper case 200 are inserted into the lower case 100 so as to be in contact with the back side wall 114 of the lower case 100, and the lower insertion pieces 150 of the lower case 100 are inserted into the upper case 200 so as to be in contact with the back side wall 224 of the upper case 200, the upper insertion pieces 240 of the upper case 200 and the lower insertion pieces 150 of the lower case 100 are alternately arranged. This can reduce the lateral displacement of the upper and lower cases 200 and 100, thereby ensuring the accommodation of the secondary battery 300 in the secondary battery storage case 800.

As illustrated in FIGS. 1 and 2, an upper portion of the back side wall 224 of the upper case 200 includes a handle 260 used to remove the battery pack 900 after the battery pack 900 has been attached to a device to which the battery pack 900 is to be attached. The device to which the battery pack 900 is to be attached is not specifically limited, and examples of the device include mobile phones, laptop personal computers, and portable CD and MD players.

The upper insertion pieces 240 of the upper case 200 are provided at least adjacent to the handle 260 in lateral directions. Although stress is applied to the vicinity of the handle 260 to remove the battery pack 900 while grasping the handle 260, the upper insertion pieces 240 of the upper case 200 are provided in the vicinity of the handle 260 as described above, and thus, when the battery pack 900 is removed with the handle 260 grasped, the upper and lower cases 200 and 100 are less likely to be detached from each other.

The configuration of the upper insertion pieces 240 is not limited to the configuration in which the upper insertion pieces 240 are provided adjacent to the handle 260 in lateral directions, and an upper insertion piece 240 having a larger width than the handle 260 may be provided, for example, below the handle 260. This configuration also can make it difficult for the upper and lower cases 200 and 100 to be detached from each other when the battery pack 900 is removed with the handle 260 grasped.

Next, a method for assembling a battery pack 900 using the above-described secondary battery storage case 800 will be described.

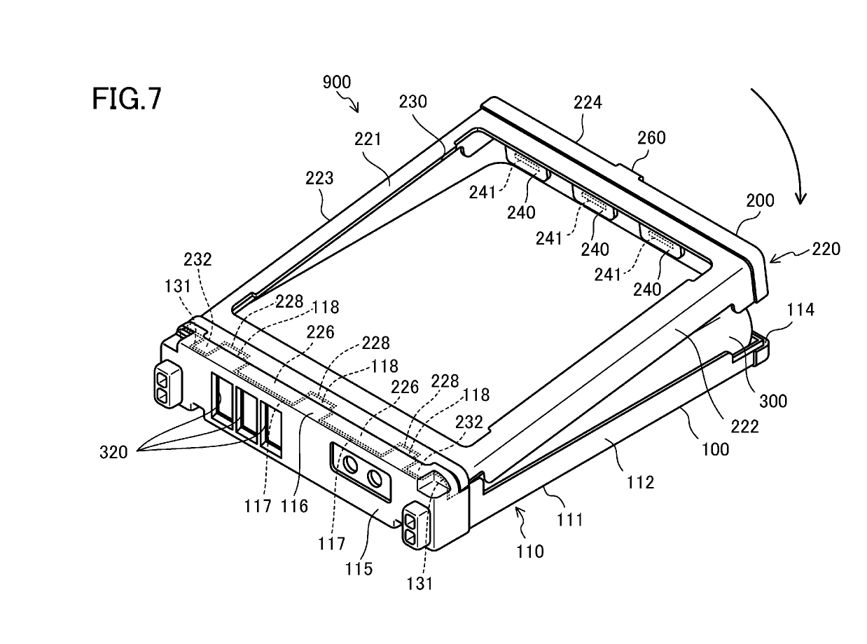

FIG. 7 is a diagram illustrating a situation where upper and lower cases 200 and 100 are aligned with each other by inserting the upper case 200 into the lower case 100 from an oblique angle.

As illustrated in FIG. 7, a secondary battery 300 is placed on a bottom plate 111 of the lower case 100, and roof insertion pieces 226 are inserted into insertion recesses 117 formed in a lower surface of a roof sheet portion 116 such that the upper case 200 is inclined relative to the lower case 100. In this case, protruding portions 118 of the roof sheet portion 116 are inserted into corresponding recesses 228 formed in a front portion of a top 221. Furthermore, a sheet-like protruding portion 232 of each of L-shaped insertion pieces 231 illustrated in FIG. 1 is inserted into a corresponding one of L-shaped recesses 131.

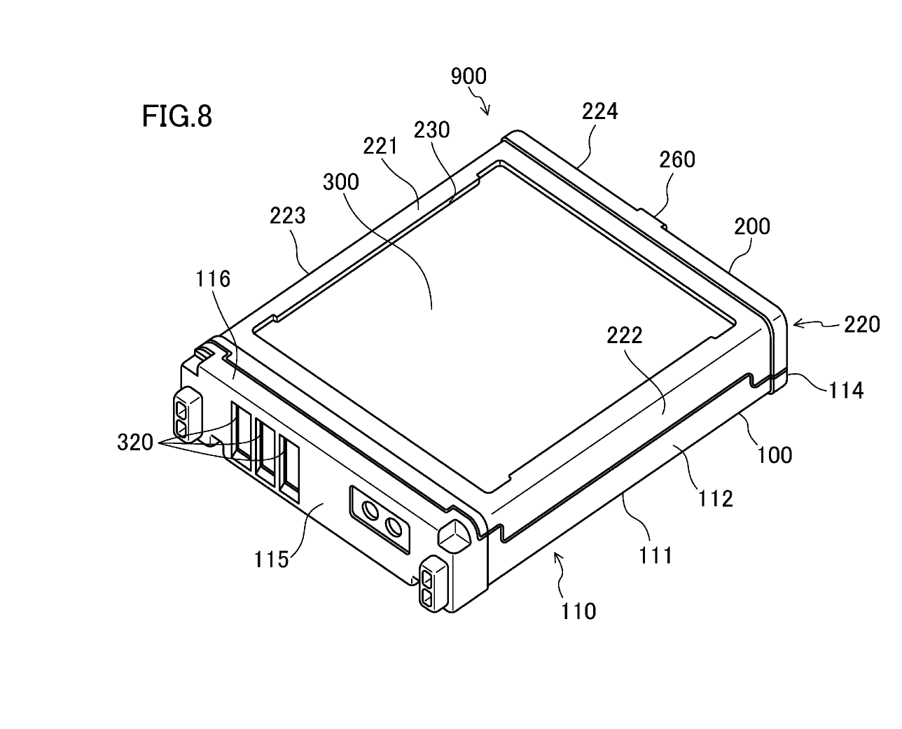

FIG. 8 is a diagram illustrating a situation where the secondary battery 300 is housed in the secondary battery storage case 800. When a back side wall 224 of the upper case 200 and a back side wall 114 of the lower case 100 are brought closer to each other in a direction illustrated by the arrow in FIG. 7, upper insertion pieces 240 of the upper case 200 are inserted into the lower case 100 so as to be in contact with the back side wall 114 of the lower case 100 as illustrated in FIGS. 5 and 8. Furthermore, as illustrated in FIGS. 6 and 8, lower insertion pieces 150 of the lower case 100 are inserted into the upper case 200 so as to be in contact with the back side wall 224 of the upper case 200. Thus, the secondary battery 300 is appropriately housed in the secondary battery storage case 800.

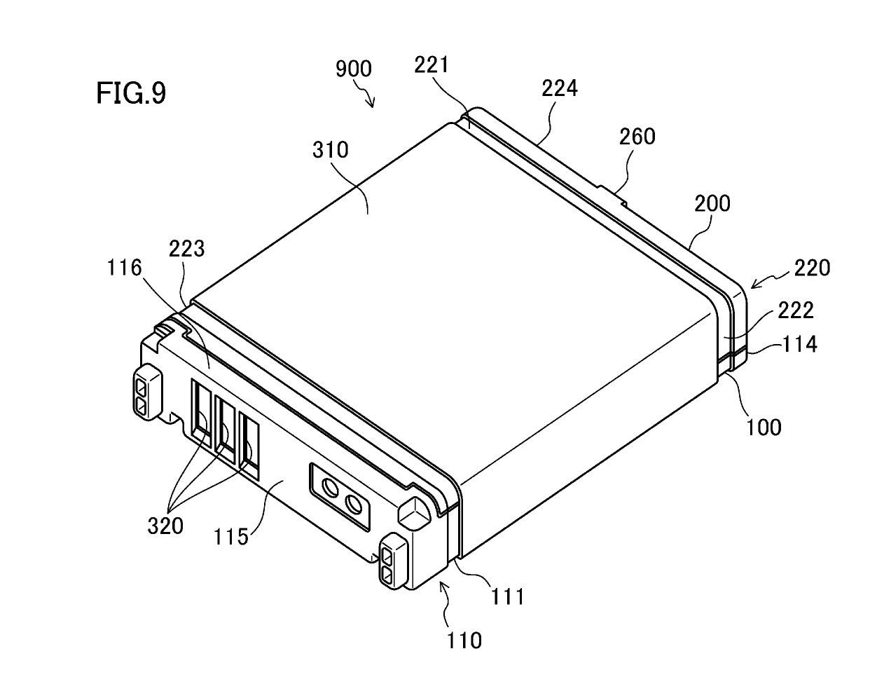

FIG. 9 is a diagram illustrating a situation where the secondary battery storage case 800 and the secondary battery 300 are coated with an exterior label. As illustrated in FIG. 9, after the secondary battery 300 has been housed in the secondary battery storage case 800, the upper case 200, the lower case 100, and the secondary battery 300 are coated with an exterior label 310. This allows the exterior label 310 to firmly support the upper and lower cases 200 and 100, thereby preventing the upper and lower cases 200 and 100 from being detached from each other. This prevention can ensure the accommodation of the secondary battery 300 in the storage case, and allows, e.g., necessary information to be printed on the exterior label 310, thereby facilitating handling the battery pack 900. Furthermore, when the exterior label 310 is an insulating material, insulation of the secondary battery 300 from, e.g., other electronic components can be ensured.

When, in the battery pack 900 of this embodiment, the upper and lower cases 200 and 100 are to be detached from each other, the upper case 200 needs to be lifted in the direction opposite to the direction illustrated by the arrow in FIG. 7; however, as illustrated by the arrow in FIG. 5, the upper insertion pieces 240 of the upper case 200 are sandwiched between the secondary battery 300 and the back side wall 114 of the lower case 100; and as illustrated by the arrow in FIG. 6, the lower insertion pieces 150 of the lower case 100 are sandwiched between the secondary battery 300 and the back side wall 224 of the upper case 200. Thus, even when the secondary battery 300 produces heat to expand during operation of, e.g., a mobile phone to which the battery pack 900 is attached, the upper case 200 is less likely to be lifted in the direction opposite to the direction illustrated by the arrow in FIG. 7, and the upper and lower cases 200 and 100 are less likely to be detached from each other, because the upper insertion pieces 240 of the upper case 200 and the lower insertion pieces 150 of the lower case 100 are firmly sandwiched between the secondary battery 300 and the corresponding side walls. Therefore, the secondary battery storage case 800 of this embodiment can appropriately house the secondary battery 300.

### Other Embodiments

In the embodiment, the upper case 200 includes the plurality of upper insertion pieces 240, and the lower case 100 includes the plurality of lower insertion pieces 150. However, the scope of the invention is not limited to the embodiment. For example, only the upper case 200 may include one or more upper insertion pieces 240. Alternatively, only the lower case 100 may include one or more lower insertion pieces 150.

In the embodiment, the upper insertion pieces 240 of the upper case 200 each have the locking recess 241, and the front portion of the back side wall 114 of the lower case 100 includes the locking portions 141 that are inserted into the corresponding recesses 241 and are capable of locking the upper insertion pieces 240.

However, the scope of the invention is not limited to the embodiment. Locking recesses may be formed in the lower insertion pieces 150 of the lower case 100, and a front portion of the back side wall 224 of the upper case 200 may include locking portions that are inserted in to the corresponding recesses and are capable of locking the lower insertion pieces 150.

### INDUSTRIAL APPLICABILITY

The battery pack of the present disclosure can be used as a power source of an electronic device, such as a mobile phone, a laptop personal computer, or a portable CD or MD player.

### DESCRIPTION OF REFERENCE CHARACTERS

100 LOWER CASE
110 SURROUNDING SIDE WALL
111 BOTTOM PLATE
112 LEFT SIDE WALL
113 RIGHT SIDE WALL
114 BACK SIDE WALL
115 FRONT SIDE WALL
116 ROOF SHEET PORTION
117 INSERTION RECESS
118 PROTRUDING PORTION
141 LOCKING PORTION
150 LOWER INSERTION PIECE
200 UPPER CASE
220 SURROUNDING SIDE WALL
221 TOP
222 LEFT SIDE WALL
223 RIGHT SIDE WALL
224 BACK SIDE WALL
226 ROOF INSERTION PIECE
228 RECESS
230 OPENING
231 L-SHAPED INSERTION PIECE
240 UPPER INSERTION PIECE
241 LOCKING RECESS
250 INSERTION RECESS
260 HANDLE
300 SECONDARY BATTERY
301 MOLDING
302 CIRCUIT SUBSTRATE
310 EXTERIOR LABEL
320 EXTERNAL CONNECTION TERMINAL OPENING
800 SECONDARY BATTERY STORAGE CASE
900 BATTERY PACK

1. A battery pack comprising:
a secondary battery storage case including a lower case, and an upper case joined to the lower case; and
a secondary battery housed in the secondary battery storage case, wherein
the lower case includes a bottom plate, and a surrounding side wall standing around the bottom plate so as to be directed upward, and including left, right, front, and back side walls,
the upper case includes a top, and a surrounding side wall standing around the top so as to be directed downward, and including left, right, and back side walls,
an upper portion of the front side wall of the lower case includes a flat roof sheet portion protruding backward in a direction parallel to the bottom plate,
a front portion of the top of the upper case includes a flat roof insertion piece that is inserted into the roof sheet portion so as to be in contact with the roof sheet portion and protrudes frontward in a direction parallel to the top,
at least one of an upper insertion piece of the back side wall of the upper case or a lower insertion piece of the back side wall of the lower case is provided, where the upper insertion piece is inserted into the lower case so as to be in contact with the back side wall of the lower case, and the lower insertion piece is inserted into the upper case so as to be in contact with the back side wall of the upper case, and
a space surrounded by the top and surrounding side wall of the upper case and the bottom plate and surrounding side wall of the lower case is formed as a space for housing the secondary battery by inserting the roof insertion piece of the upper case into the lower case such that the roof insertion piece is in contact with the roof sheet portion of the lower case, and at least either inserting the upper insertion piece into the lower case such that the upper insertion piece is in contact with the back side wall of the lower case, or inserting the lower insertion piece into the upper case such that the lower insertion piece is in contact with the back side wall of the upper case to house the secondary battery in the secondary battery storage case.

2. The battery pack of claim 1, wherein
a locking recess is formed in the upper insertion piece of the upper case, and
a front portion of the back side wall of the lower case includes a locking portion that is inserted into the locking recess and is capable of locking the upper insertion piece.

3. The battery pack of claim 1, wherein
a locking recess is formed in the lower insertion piece of the lower case, and
a front portion of the back side wall of the upper case includes a locking portion that is inserted into the locking recess and is capable of locking the lower insertion piece.

4. The battery pack of any one of claim 1, wherein
an insertion recess is formed in the front portion of the back side wall of the upper case, and
the lower insertion piece of the lower case is inserted into the insertion recess.

5. The battery pack of any one of claim 1, wherein
an insertion recess is formed in a lower portion of the roof sheet portion of the lower case, and
the roof insertion piece of the upper case is inserted into the insertion recess.

6. The battery pack of any one of claim 1, wherein
the roof sheet portion of the lower case includes a protruding portion inserted into the upper case so as to be in contact with the top of the upper case and protruding backward.

7. The battery pack of any one of claim 1, wherein
the upper insertion piece of the upper case includes a plurality of upper insertion pieces,
the lower insertion piece of the lower case includes a plurality of lower insertion pieces,
the upper insertion pieces and the lower insertion pieces are alternately arranged along a lateral direction,
the upper insertion pieces of the upper case are inserted into the lower case so as to be in contact with the back side wall of the lower case, and
the lower insertion pieces of the lower case are inserted into the upper case so as to be in contact with the back side wall of the upper case.

8. The battery pack of any one of claim 1, wherein
at least a left or right end portion of the upper case includes an L-shaped insertion piece extending from a location within the front portion of the top to a front portion of a corresponding one of the left and right side walls and having an L-shaped cross section, and
the L-shaped insertion piece is inserted into the lower case so as to be in contact with the roof sheet portion and a corresponding one of the left and right side walls of the lower case.

9. The battery pack of any one of claim 1, wherein
an upper portion of the back side wall of the upper case includes a handle used to lift a back end portion of the upper case to remove the battery pack after attaching the battery pack, and
the upper insertion piece of the upper case is provided adjacent to the handle in a lateral direction or below the handle.

10. The battery pack of any one of claim 1, wherein
an opening is formed in each of a central portion of the top of the upper case and a central portion of the bottom plate of the lower case.

11. The battery pack of any one of claim 1, wherein
the upper case, the lower case, and the secondary battery are coated with an exterior label.

12. A box-shaped secondary battery storage case, comprising:
a lower case; and
an upper case joined to the lower case, wherein
the lower case includes a bottom plate, and a surrounding side wall standing around the bottom plate so as to be directed upward, and including left, right, front, and back side walls,
the upper case includes a top, and a surrounding side wall standing around the top so as to be directed downward, and including left, right, and back side walls,
an upper portion of the front side wall of the lower case includes a flat roof sheet portion protruding backward in a direction parallel to the bottom plate,
a front portion of the top of the upper case includes a flat roof insertion piece that is inserted into the roof sheet portion so as to be in contact with the roof sheet portion and protrudes frontward in a direction parallel to the top,
at least one of an upper insertion piece of the back side wall of the upper case or a lower insertion piece of the back side wall of the lower case is provided, where the upper insertion piece is inserted into the lower case so as to be in contact with the back side wall of the lower case, and the lower insertion piece is inserted into the upper case so as to be in contact with the back side wall of the upper case, and
a space surrounded by the top and surrounding side wall of the upper case and the bottom plate and surrounding side wall of the lower case is formed as a space for housing the secondary battery by inserting the roof insertion piece of the upper case into the lower case such that the roof insertion piece is in contact with the roof sheet portion of the lower case, and at least either inserting the upper insertion piece into the lower case such that the upper insertion piece is in contact with the back side wall of the lower case, or inserting the lower insertion piece into the upper case such that the lower insertion piece is in contact with the back side wall of the upper case.

13. A method for assembling a battery pack while housing a secondary battery in a box-shaped secondary battery storage case including a lower case and an upper case joined to the lower case, where the lower case includes a bottom plate, a surrounding side wall standing around the bottom plate so as to be directed upward, and including left, right, front, and back side walls, a flat roof sheet portion provided on an upper portion of the front side wall to protrude backward in a direction parallel to the bottom plate, and a lower insertion piece provided on the back side wall, and the upper case includes a top, a surrounding side wall standing around the top so as to be directed downward, and including left, right, and back side walls, a flat roof insertion piece provided on a front portion of the top, inserted into the roof sheet portion so as to be in contact with the roof sheet portion and protruding frontward in a direction parallel to the top, and an upper insertion piece provided on the back side wall, the method comprising steps of:
placing the secondary battery on the bottom plate of the lower case;
obliquely inserting the upper case into the lower case including the bottom plate on which the secondary battery has been placed, such that the roof insertion piece of the upper case is inserted into the lower case so as to be in contact with the roof sheet portion of the lower case; and
bringing the back side wall of the upper case closer to the back side wall of the lower case, and housing the secondary battery in the secondary battery storage case at least either by inserting the upper insertion piece into the lower case such that the upper insertion piece is in contact with the back side wall of the lower case, or by inserting the lower insertion piece into the upper case such that the lower insertion piece is in contact with the back side wall of the upper case.
